(19) United States
(12) Patent Application Publication
(10) Pub. No.: US 2006/0152998 A1
(43) Pub. Date: Jul. 13, 2006

(54) Acoustic fluidized bed

(76) Inventors: Ronald F. Burr, Richmond, VA (US); Vernon Wade Popham, Bend, OR (US)

Correspondence Address: MICHAEL N. HAYNES, 1341 HUNTERSFIELD CLOSE, KESWICK, VA, 22947, US

(21) Appl. No.: 10/512,598

(22) PCT Filed: Sep. 9, 2004
(86) PCT No.: PCT/US04/29261

§ 371 Date: Oct. 21, 2004

Related U.S. Application Data
(60) Provisional application No. 60/501,889, filed on Sep. 10, 2003.
(60) Provisional application No. 60/509,520, filed on Oct. 9, 2003.

(51) Int. Cl. B01F 11/00

(52) U.S. Cl. 366/116; 366/110

(57) ABSTRACT

Certain exemplary embodiments comprise a method comprising: via a drive: generating an acoustic standing wave in an impeller-less chamber, the acoustic standing wave having a velocity below approximately 0.3 Mach, the chamber containing particles, the chamber non-destructively detachable from the drive, a system comprising the drive, the chamber, and the particles defining a mechanical resonant frequency having a value other than an acoustic resonant frequency of the chamber; and, acoustically fluidizing particles contained in the chamber.

### CROSS-REFERENCES TO RELATED APPLICATIONS

This application is a National Stage submission (filed under 35 U.S.C. 371) of, claims priority to, and incorporates by reference herein in its entirety, PCT Application PCT/US04/29261, filed 9 Sep. 2004.

### BRIEF DESCRIPTION OF THE DRAWINGS

A wide variety of potential embodiments will be more readily understood through the following detailed description of certain exemplary embodiments, with reference to the accompanying drawings in which:

FIG. 1 is a block diagram of an exemplary embodiment of a system 1000 comprising unmixed particles;

FIG. 2 is a block diagram of an exemplary embodiment of a system 1000 comprising mixing particle motion and bubbling fluidization;

FIG. 3 is a block diagram of an exemplary embodiment of a system 1000 comprising mixing particles;

FIG. 4 is a block diagram of an exemplary embodiment of a system 1000 comprising mixed particles;

FIG. 5 is a block diagram of an exemplary embodiment of a system 3000;

FIG. 6 is a flowchart of an exemplary embodiment of a method 4000; and

FIG. 7 is a block diagram of an exemplary embodiment of an information device 5000.

### DEFINITIONS

When the following terms are used herein, the accompanying definitions apply:
acoustic resonant frequency—a frequency that produces an acoustic standing wave of maximum amplitude for a given input amplitude.
acoustic standing wave—a sound wave characterized by amplitude that may vary with spatial location but remains constant over time at each spatial location.
acoustically fluidize—to cause to behave as a fluid via the use of sound and/or variations in air pressure.
can—is capable of, in at least some embodiments.
chamber—an enclosed space or compartment.
circulate—to repeatedly move in or flow through a closed path.
closure—a device for enclosing an opening of a container.
comprising—including but not limited to.
contain—to hold or keep within limits; restrain.
controller—a device and/or set of machine-readable instructions for performing one or more predetermined and/or user-defined tasks. A controller can comprise any one or a combination of hardware, firmware, and/or software. A controller can utilize mechanical, pneumatic, hydraulic, electrical, magnetic, optical, informational, chemical, and/or biological principles, signals, and/or inputs to perform the task(s). In certain embodiments, a controller can act upon information by manipulating, analyzing, modifying, converting, transmitting the information for use by an executable procedure and/or an information device, and/or routing the information to an output device. A controller can be a central processing unit, a local controller, a remote controller, parallel controllers, and/or distributed controllers, etc. The controller can be a general-purpose microcontroller, such the Pentium IV series of microprocessor manufactured by the Intel Corporation of Santa Clara, Calif., and/or the HC08 series from Motorola of Schaumburg, Ill. In another embodiment, the controller can be an Application Specific Integrated Circuit (ASIC) or a Field Programmable Gate Array (FPGA) that has been designed to implement in its hardware and/or firmware at least a part of an embodiment disclosed herein.
distinct—readily distinguishable from all others; discrete.
dominant frequency—a frequency corresponding to maximum amplitude response, usually associated with the fundamental or first mode (i.e., mode=1) of a wave.
drive—(n) the means or apparatus for transmitting motion or power to a machine or from one machine part to another.
drive—(v) to supply the motive force or power to and cause to function.
drive parameters—variables associated with operating and/or the operation of a drive.
driven by—receiving motive force or power from.
generate—to bring into being; give rise to.
impeller—a rotating device used to force a fluid or material motion in a desired direction.
impeller-less—lacking an impeller.
levitate—to rise, or tend to rise, as if lighter than the surrounding medium; to become buoyant.
longitudinal—of or relating to longitude or length.
Mach—a number representing the ratio of the speed of a body, particle, and/or point on a wave to the speed of sound in a surrounding medium (such as air).
may—is allowed to, in at least some embodiments.
mechanical resonant frequency—a natural frequency of a structure and/or mechanical system.
mechanical system—a collection of mechanically coupled components, each of those components affecting a motion and vibration of the collection via their contribution of mass, stiffness, and/or damping.
mixedness—the degree of mixing of two or more substances.
modulation—a variety of techniques for encoding information on a carrier signal, typically a sine-wave signal; variation, typically with time or frequency.
non-destructively—of, relating to, or being a process that does not result in damage to the subject material and/or product.
non-destructively detachable—designed to be unfastened or disconnected without damage.
opening—an aperture.
opposing—opposite; against; being the other of two complementary or mutually exclusive things; placed or located directly across from something else or from each other.
particle—a small piece or part. A particle can be and/or be comprised by a powder, bead, crumb, crystal, dust, grain, grit, meal, pounce, pulverulence, and/or seed, etc.
plurality—the state of being plural and/or more than one.
portion—a part or component of an item.
predetermined—established in advance.
pulse width modulated—encoded via pulse width modulation.
pulse width modulation—a technique for controlling analog circuits with a digital outputs via which the duration and/or spacing of each digital pulse is varied.
removably—to be able to move from a place or position occupied.
seal—to shut close; to keep close; to make fast; to keep secure; to prevent leakage.
set—a collection of distinct elements having specific common properties.
signal—detectable transmitted energy that can be used to carry information.
substantially—to a great extent or degree.
system—a collection of mechanisms, devices, data, and/or instructions, the collection designed to perform one or more specific functions.
thoroughly mix—to substantially blend distinct components, so that their ratios are substantially identical throughout the whole.
velocity—a time rate of change of displacement.
vibrate—to move back and forth or to and fro, especially rhythmically and/or rapidly.
wavelength—the distance between one peak or crest of a wave.

### DETAILED DESCRIPTION

### Overview of Certain Exemplary Embodiments

Certain exemplary embodiments of an acoustic fluidized bed (AFB) can utilize acoustic principles to transfer energy from a mechanical driver via an acoustic or gas dynamic medium (e.g., a gas or vapor) to materials (e.g., powder, slurry, liquid, etc.) contained within a chamber.

The AFB can comprise a drive portion and a chamber portion. Into the chamber portion can be provided one or more materials (e.g., powder, solid, slurry, liquid, vapor, and/or fluid, etc.). The AFB potentially can be utilized for performing any of a wide variety of processes on certain target materials, including blending, mixing, separation, segregation, filtering, grinding, micronization, agglomeration, drying (with or without supplemental heat), heat exchange, heat extraction, mass exchange, reaction, reduction, oxidation, combustion, and/or remediation, etc. The AFB can have utility for target materials that primary comprise one or more powders. The AFB can have utility for pharmaceutical, neutraceuticals, cosmetics, chemical, food, electronics, materials, and/or biological production processes.

The AFB can be operated below, near, at, and/or above the resonant frequency of the AFB (which can tend to be dominated and/or strongly influenced by the mechanical, rather than the acoustic components). The AFB can be designed to operate over nearly any range of frequencies, including, for example, from approximately 30 Hz to approximately 300 Hz. The AFB can include a driver that has a very high or no resonant frequency, yet sufficient driving force. This driver is sometimes referred to herein as a sonic blender drive.

The AFB can be designed and/or operated to create, extinguish, increase, decrease, minimize, maximize, and/or optimize any desired parameter, including any desired operating parameter.

Various operating parameters of the AFB such as, for example, drive power, amplitude, frequency, duty cycle, chamber shape, powder size, fill level, types of motion, secondary powder motions, and/or operation time, etc. can be measured, varied, characterized, modeled, optimized, and/or stored, potentially in real-time, and potentially at least partially automatically. When stored, such operating parameters can be used for estimating operating parameters, including optimal operating parameters, for other powders, including powders not for which operating parameters were not previously measured, varied, characterized, modeled, optimized, and/or stored. Such operating parameter estimation can be performed at least partially automatically.

The AFB can be operated as a hybrid fluidized bed, utilizing both acoustics and an externally generated gas flow. An external fluid pressure source can be applied to the inside of the chamber of the AFB, to increase the fluid pressure within the chamber. The AFB can be operated by either constant or oscillating applied external flow.

The AFB can be implemented as a powder blending device, sometimes referred to as a “sonic blender”. This device can comprise or be coupled to a drive sometimes referred to herein as an Entire Blender Drive (EBD), which can move and/or vibrate the entire chamber at least axially. The EBD can comprise a variable reluctance linear motor (VRLM), yet other types of motors (e.g., rotary+eccentric, rotary+crank, rotary+cam, linear voice coils, moving coil, moving magnet, permanent magnet, etc.) are envisioned as capable of potentially providing acceptable and/or similar performance.

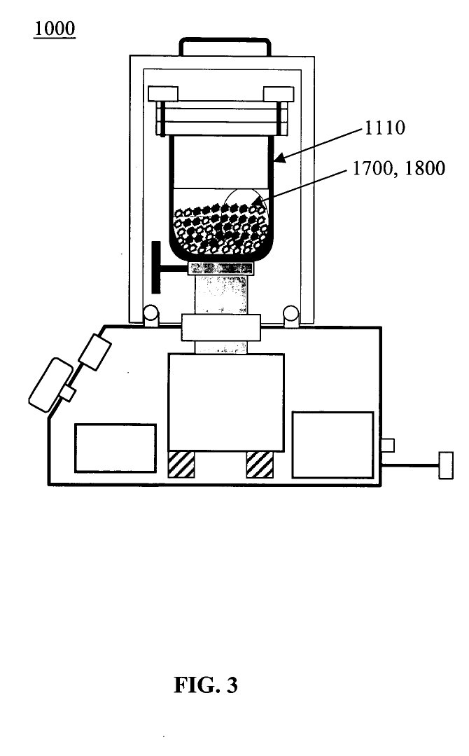

The AFB can be operated by either diaphragm or piston drive (see FIG. 3). The drive can be separated from direct contact with the powder.

When utilized as a powder blending device (but not necessarily limited to that application), the AFB can provide a number of qualities that can be viewed as acceptable and/or desirable, including for example:
effectiveness (e.g., speed of mixing, uniformity of mixing, range of particle sizes, densities and shapes, etc.);
gentleness (e.g., no high speed impeller blades to damage products by mechanical contact or heat generation);
efficiency (e.g., power consumption and/or waste heat generation);
drive controllability (e.g., amplitude, frequency, displacement signal, complex time-varying patterns, and/or superpositions of amplitude and/or frequency content, etc.);
in-situ sampling and feedback to the drive and/or controller (e.g., due to lack of gross chamber movement, i.e. rotation, and the lack of in-chamber moving parts, e.g., blades and/or agitators);
in-situ monitoring and feedback to the drive and/or controller (e.g., via clear vessels and/or covers providing direct visual information, via video, and/or via measurements, etc.);
in-situ measurements and feedback to the drive and/or controller (e.g., optical properties, reflection, refraction, temperature, pressure, conductivity) (e.g., such as via infrared spectroscopy, RTD, thermo-couple, etc.);
cleanability (e.g., chamber can lack any impediments or complex surfaces or seals other than the cover);
reliability and low maintenance (e.g., no moving parts inside chamber portion or seals through chamber, also linear motor has no bearings, lubricants, or sliding contacts to wear);
pourability (e.g., smooth hopper-shaped top portion);
removability and interchangability (e.g., chamber portion is easily removable from drive portion and may be replaced with another chamber of equal or different size and/or shape);
transportability (e.g., chamber portion can be sealed and separated from drive portion);
storage capability (e.g., chamber portion can be any of a variety of sizes, any of which can be removed from drive portion and stored);
cost (e.g., due to few moving parts and simple linear motor);
multi-functionality (e.g., multiple functions can be performed in chamber portion);
sedimentation (e.g., by performing multiple functions in chamber, and avoiding certain transfers, segregation and/or sedimentation of powder is less likely to occur); and/or
ability to operate chamber at a wide range of fill levels (from empty to loosely packed full).
Certain exemplary embodiments comprise a method comprising: via a drive: generating an acoustic standing wave in an impeller-less chamber, the acoustic standing wave having a velocity below approximately 0.3 Mach, the chamber containing particles, the chamber non-destructively detachable from the drive, a system comprising the drive, the chamber, and the particles defining a mechanical resonant frequency having a value other than an acoustic resonant frequency of the chamber; and, acoustically fluidizing particles contained in the chamber.

Certain exemplary embodiments can comprise a system, comprising: a impeller-less chamber defining a longitudinal axis, a length oriented substantially parallel to said longitudinal axis, and an opposing pair of ends, said chamber adapted to receive at least two distinct sets of particles; a closure adapted to removably seal an opening defined at one end of said opposing pair of ends and to contain particles within said chamber; and a drive adapted to: receive and be driven by a pulse width modulated signal; vibrate said chamber along said longitudinal axis at a frequency less than a mechanical resonant frequency of a mechanical system that comprises the drive and the chamber, and at a wavelength substantially longer than the chamber length; acoustically fluidize particles contained in said chamber; substantially thoroughly mix particles contained in said chamber; and non-destructively detach from said chamber.

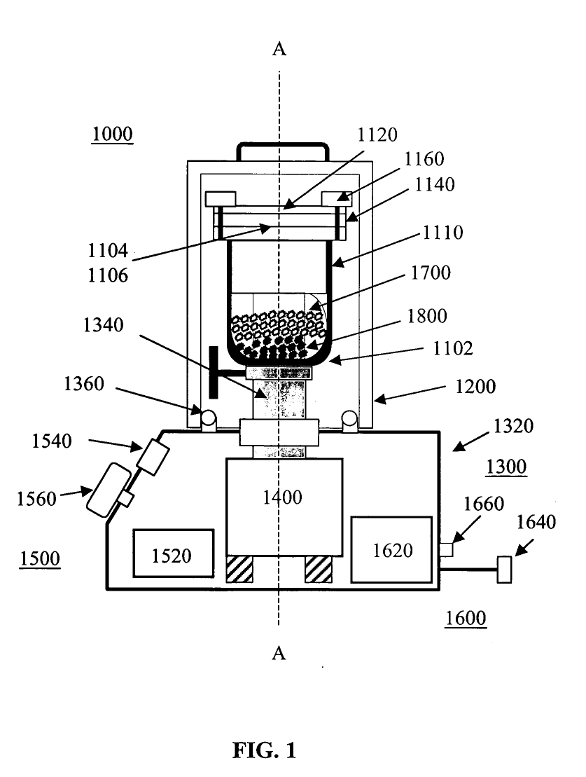

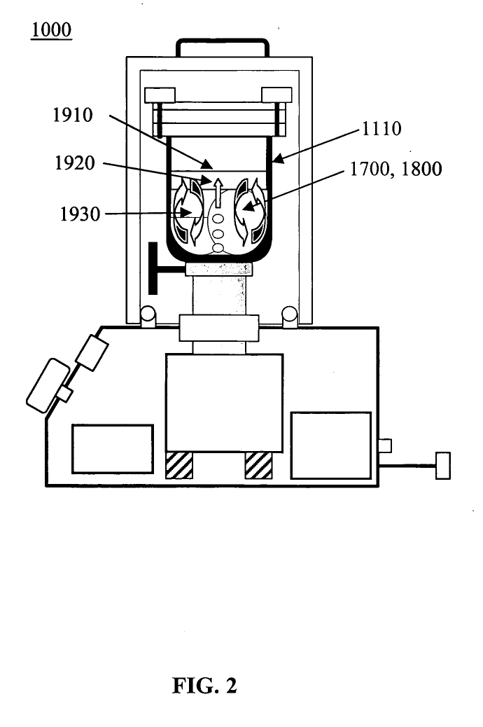

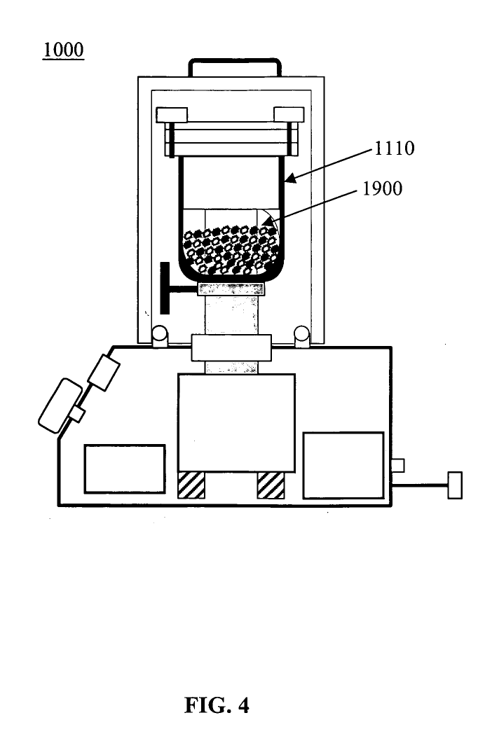

FIG. 1 is a block diagram of an exemplary embodiment of a system 1000 comprising unmixed particles, FIG. 2 is a block diagram of an exemplary embodiment of a system 1000 showing a possible flow pattern for mixing particles; FIG. 3 is a block diagram of an exemplary embodiment of a system 1000 comprising mixing particles; and FIG. 4 is a block diagram of an exemplary embodiment of a system 1000 comprising mixed particles.

Referring to FIG. 1, system 1000 can comprise a mixing chamber 1100, which can be formed in any shape, such as a shape that enhances mixing, circulation, and/or processing of particles contained therein. Mixing chamber 1100 can be shaped substantially symmetrically about a longitudinal axis A-A thereof. Mixing chamber 1100 can be substantially transparent. Mixing chamber 1100 can be constructed of a polymer such as acrylic, ABS, and/or polycarbonate, etc., and/or a metal such as stainless steel. Mixing chamber 1100 can comprise one or more carrying, lifting, and/or pouring handles.

Mixing chamber 1100 can define two opposing ends 1102, 1104, at least one of which can define an opening 1106 in mixing chamber 1100. For example, mixing chamber 1100 can define one or more openings 1106, any of which can be located at a top, side, and/or bottom of chamber 1100. Fluidically coupled to, at, and/or adjacent any opening 1106 can be a valve for controlling entry to and/or exit from chamber 1100. As shown, opening 1106 can be located at a top of chamber 1100 so that particles can be easily poured into chamber 1100. A closure, such as a removable lid 1120, a gasket 1140, and/or lid clamps 1160, can be used to seal opening 1106, thereby fully enclosing mixing chamber 1100. Lid 1120 can be transparent, and/or can be constructed of a polymer such as acrylic, ABS, and/or polycarbonate, etc., and/or a metal such as stainless steel. Gasket 1140 can be captured by lid clamps 1160, FDA-approved, and/or constructed of a material such as rubber, neoprene, polyurethane, etc.

Mixing chamber 1100 can attach to a base unit 1300, such as via a clamping device 1340 which can clamp to a bottom and/or perimeter of mixing chamber 1100. One or more locating pins can assist with aligning mixing chamber 1100 to base unit 1300. A sound enclosure 1200, which can be transparent, can at least partially surround mixing chamber 1100, thereby assisting with attenuating sounds and/or noise emanating from system 1000, mixing chamber 1100, and/or base unit 1300. One or more locating pins 1360 can assist with aligning sound enclosure 1200 to base unit 1300.

Base unit 1300 can comprise an enclosure 1320, which can be constructed of a durable material, such as stainless steel. Enclosure 1320 can surround and/or enclose a drive 1400, controller 1500, and/or power supply 1600, each of which can be operatively interconnected. Controller 1500 can comprise a controller printed circuit board 1520, an LCD display 1540, an encoder 1560, and/or associated interconnections, etc. Controller 1500 can receive, store, and/or render user-defined processing parameters, such as recipes, programs, etc., such as via LCD display 1540, which can render user-specified menus and/or a user-defined graphical user interface. Power supply 1600 can comprise a power supply printed circuit board 1620, a power cord 1640, and/or an On/Off switch 1560, etc.

As shown in FIG. 2, within a volume defined by mixing chamber 1100 can be any number of initially distinct sets of particles, 1700, 1800, which can fill chamber 1100 to a fill line 1910. Via operation of system 1000, within chamber 1100, acoustic energy can be applied to the sets of particles to cause a fluidization and bubbling effect 1920 and/or circulatory effects 1930. The sets of particles can be mixed, such as in the patterns shown in FIG. 3, to form a substantially thoroughly mixed particle set 1900, such as shown in FIG. 4. Particles contained within mixing chamber 1100 can be poured out of mixing chamber 1100 after first removing lid 1120.

The inner surface of mixing chamber 1100 can be substantially smooth, thereby aiding in circulation, mixing, and/or the removal of particles. Mixing chamber 1100 can be substantially free and/or devoid of oils, lubricants, etc., thereby avoiding contamination of any particles contained therein. Because mixing chamber 1100 can be substantially free and/or devoid of mechanical components, such as blades, impellers, drive shaft, etc., damage to particles contained in mixing chamber 1100 can be minimized, emptying and/or cleaning of mixing chamber 1100 can be relatively simple and rapid, and/or multiple empty mixing chambers can be stacked, thereby minimizing their storage space.

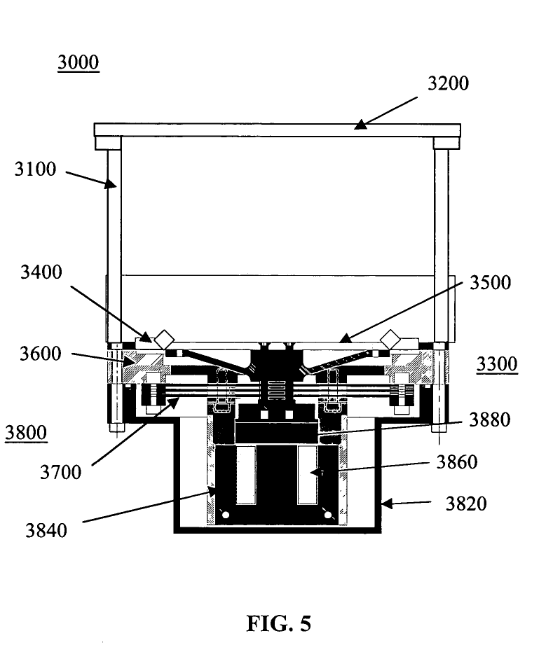

FIG. 5 is a block diagram of an exemplary embodiment of a system 3000, which can comprise a mixing chamber 3100, which can be sealed by a lid 3200. Mixing chamber 3100 can be coupled to a drive 3300, which can comprise components for applying acoustical energy to mixing chamber 3100. For example, drive 3300 can comprise a diaphragm 3400, which can be coupled to a piston 3500 to form and/or border a bottom surface of mixing chamber 3100. A suspension 3700 can oppose certain motions of piston 3500, and/or provide restoring forces that oppose certain forces imparted on piston 3500, such as via motor 3800. An adapter plate 3600 can couple motor 3800 to mixing chamber 3100. Motor 3800 can comprise a non-contact linear motor that can be welded, bearing-free, and/or be seal-free. Motor 3800 can comprise a motor enclosure 3820, a stator 3840, a coil 3860, and/or an armature 3880. Motor 3800 can be constructed of magnetic and/or stainless steels.

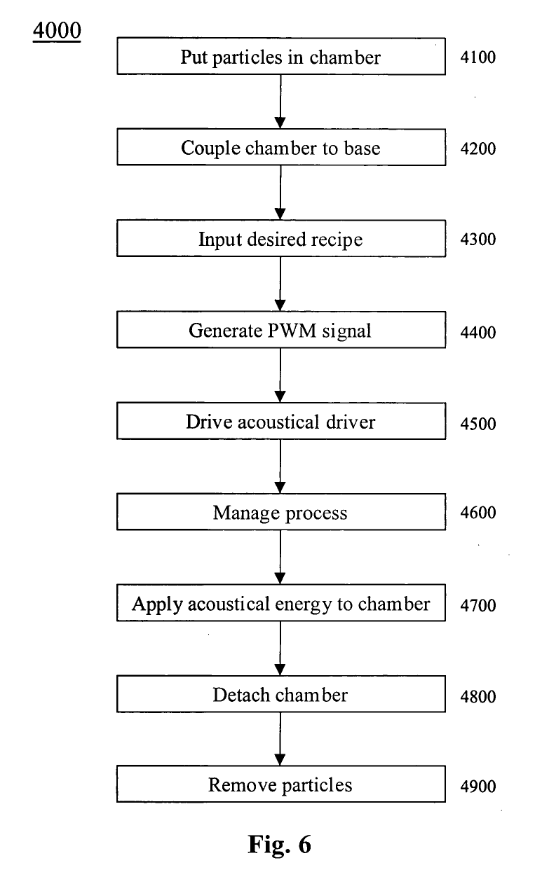

FIG. 6 is a flowchart of an exemplary embodiment of a method 4000. At activity 4100, a first set of particles can be poured into the chamber. Then, if desired, a second set of particles can be poured into the chamber. Additional distinct sets of particles can be added as desired. The particles can cumulatively fill the chamber to between approximately 3 percent and approximately 90 percent of an internal volume of the chamber. Each particle can have an average maximum dimension of between approximately 1 micrometer and approximately 1000 micrometers. The chamber can be shaped to enhance circulation the particles contained therein when the chamber is acoustically driven.

At activity 4200, the chamber can be coupled to the base, which can comprise the acoustical drive and/or a controller. At activity 4300, a plurality of user-desired processing and/or operating parameters can be received and/or input, such as via selecting a recipe, process, procedure, protocol, and/or program, etc., from a menu and/or graphical user interface. At activity 4400, the controller can calculate, determine, obtain, and/or generate a pulse width modulated signal that corresponds to the user-desired processing parameters. At activity 4500, the acoustical drive can receive and/or be driven by the signal. At activity 4600, the controller and/or drive can cause properties of the process, signal, and/or the controller, drive, and/or system to be managed, e.g., rendered to a user, monitored, adjusted, stored, and/or transmitted, etc. For example, the controller can monitor and/or compensate for voltage, motor current, and/or electronic, motor, and/or cooling air temperatures.

At activity 4700, the drive can impart acoustical energy to the chamber. As one potential result, the drive can vibrate the chamber along its longitudinal axis at a frequency less than (or greater than) a mechanical resonant frequency of the mechanical system defined in part by the driver, controller, chamber, closure, and/or particles, and at a wavelength substantially longer (or substantially shorter) than the length of the chamber. As another potential result, the drive and/or system can acoustically fluidize particles contained in the chamber. As a further potential result, the drive and/or system can levitate at least a portion of the particles contained in the chamber. As yet another potential result, the drive and/or system can circulate at least a portion of the particles contained in the chamber. As still another potential result, the drive and/or system can substantially thoroughly mix the particles contained in the chamber. The particles can be substantially thoroughly mixed within approximately 2 minutes. The particles can be processed to less than approximately 2 percent relative standard deviation (RSD), which is a ratio of the standard deviation to the mean of whatever variable is used to quantify mixedness, such as pH, concentration, and/or density, etc.

The acoustical energy can create an acoustic standing wave in the chamber. The acoustic standing wave can create a maximum amplitude for a given input amplitude at the acoustic resonant frequency and/or a harmonic thereof, the acoustic resonant frequency defined by the geometry of the chamber (e.g., length, shape, and/or cross-sectional profile at various axial positions, etc.). The acoustic standing wave can have a peak, peak-to-peak, and/or RMS velocity between about 0 Mach and about 0.30 Mach, including all values and subranges therebetween, such as from about 0.01 Mach to about 0.25 Mach, below about 0.2 Mach, below about 0.1 Mach, etc.

The acoustic resonant frequency can be substantially greater than a mechanical resonant frequency of a mechanical system that can comprise the chamber, its closure, it particles, and/or its driver, etc. Thus, the acoustic standing wave can occur at a mechanical non-resonant frequency, and/or can be characterized as a non-resonant acoustic standing wave. For example, the acoustic resonant frequency can be from about 2 to about 10 times greater than the mechanical resonant frequency. As another example, the mechanical resonant frequency can have a value outside of a predetermined acoustic resonance bracket. That is, the mechanical resonant frequency can have a value either less than a predetermined value, such as approximately 30, 50, 60, 70, 75, 80, and/or 90, etc., percent, or greater than a predetermined value, such as approximately 110, 120, 125, 130, 140, 150, and/or 170, etc., percent, of the acoustic resonant frequency of the chamber. Thus, the mechanical resonant frequency can be other than the acoustic resonant frequency. The chamber can be driven below, at, near, and/or above its mechanical resonant frequency.

At activity 4800, the drive and/or system can be non-destructively detached from the chamber. For example, any clamp coupling the chamber to the base can be released, and the chamber lifted from the base.

At activity 4900, the mixed particles can be removed from the chamber. The chamber can be cleaned as desired. The method then can be repeated at activity 4100.

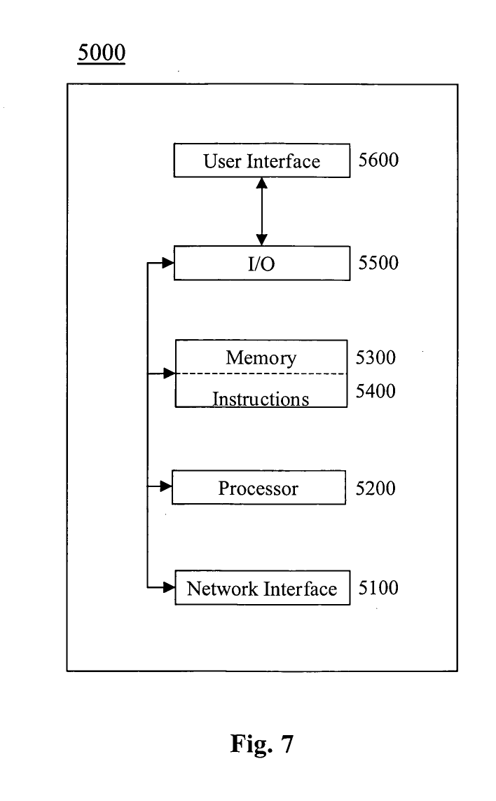

FIG. 7 is a block diagram of an exemplary embodiment of an information device 5000, which in certain operative embodiments can comprise, for example, controller 1500 of FIG. 1. Information device 5000 can comprise any of numerous well-known components, such as for example, one or more network interfaces 5100, one or more processors 5200, one or more memories 5300 containing instructions 5400, one or more input/output (I/O) devices 5500, and/or one or more user interfaces 5600 coupled to I/O device 5500, etc.

In certain exemplary embodiments, via one or more user interfaces 5600, such as a graphical user interface, a user can input, perceive a rendering of, and/or output, one or more processing programs and/or recipes; processing parameters and/or drive parameters, such as specifications, set-points, actual values, etc.; and/or messages such as notifications, warnings, alarms, and/or assistance; etc.

Potential Underlying Physics

Basic acoustic and fluidized bed theory can provide some guidance for understanding the powder blending chamber physics. However, the acoustic blending process might be very complex and might not be completely and/or properly characterized at this point.

For the purposes of this description, particular exemplary clear chambers on a breadboard (i.e., early stage experimental model) of the sonic blender are used to visualize the blending process and provide potential insight. Limited quantitative experiments have also been conducted. The breadboard chambers have been both 2-dimensional (flat) and cylindrical in cross-section with both constant and variable cross-sectional areas along the lengthwise direction. They have typically been driven using entire blender drive (EBD) approach, in which the entire chamber is vibrated axially.

The following sections describe certain basic principles potentially associated with the sonic blender operation. The text follows the flow of power from the wall outlet, through the exemplary electronic & motor drivers, and into the exemplary acoustically fluidized powder bed.

Electrical Drive Method and Circuit

An approximately 340 V pulse width modulated (PWM) electrical and/or electromagnetic signal drives the VRM-1250 (approximately 1.25″ wide center leg) variable reluctance linear motor (VRLM). The 340 VDC supply is created by doubling and rectifying 120 VAC line voltage using a pair of rectifiers and electrolytic capacitors. An “H-bridge” circuit formed with two IGBTs (insulated gate bi-polar transistors), two rectifiers, and the VRLM coil is used to switch the 340 VDC. Both positive and negative 340 V is applied to the motor, although current only flows in one direction through the motor coil. A gate driver IC converts an approximately 5V microcontroller generated PWM output to the appropriate levels (approximately 12 V gate-to-source) used to drive both the high and low side IGBTs. The microcontroller creates the PWM control signal at the desired amplitude (by adjusting the duty cycle of the pulses) and frequency using one of its timer channels.

Other electrical drive methods can include an SCR and/or diode circuit, and/or a direct AC drive with other motor types.

VRM Motor Electrical Load

The static inductance (L) of the motor is approximately 15 mH at a nominal (stationary) gap between the armature and the stator of the motor of approximately 100 mil. Coil resistance (R) is negligible in comparison to the inductance at the typical drive frequencies (e.g. approximately 100 Hz) and the electrical input impedance is dominated by the inductance:
Z(ω)=j*ω*L+R; ω*L=2*π*100*0.015=9.4Ω; R=0.3Ω

For a static inductive load, the current rises linearly when a constant voltage is applied and the peak current will be proportional to the pulse width of the voltage signal. Typical drive signals have an “on” duty cycle of approximately 15%, and thus the motor is “on” and pulling for approximately 30% of the signal period and relaxed to rebound (and overshoot) under the force of the suspension springs during the remaining time. At a typical drive frequency of approximately 100 Hz, the “on” pulse width (τ) is approximately 1.5 ms and the corresponding peak current is estimated:
I=V*τ/L=340*0.0025/0.015=35 A

Once the positive 340 V pulse is complete, the rectifiers apply approximately negative 340 V until the motor current is driven to approximately zero.

In practice, the gap is not static but varies with motor motion, and the back-EMF generated as a result of the changing reluctance (inductance) creates a mechanism by which electrical power (V*I) is transformed into mechanical power (F*V). The mechanical system provides both imaginary (resonating) and real (dissipative) components to the electrical load. Without the dissipative process, power would oscillate in and out of the motor without any net transfer to the mechanical (acoustic fluidized bed) system. Even with the dissipative mechanical (fluidized bed) loads added, the overall electrical load remains largely inductive in this particular embodiment.

Variable Reluctance Linear Motor (VRLM)

The VRLM motor produces an attractive force proportional to the square of the current and inversely proportional to the square of the gap:
F˜i²/g²

Larger (nominal) gaps allow for more motor displacement which increases mixing. Larger gaps also allow more room for error before the motor “hits” (i.e., mechanical contact occurs between the “armature” or moving member of the motor and the “stator” or stationary member of the motor). If the gap is increased too far, however, the force is diminished to the point where can no longer drive the load to the desired stroke. The ideal gap is a balance between sufficient motor force and the necessary clearance for the desired motion. Typical gaps are approximately 100 mil to approximately 300 mil. The motor suspension system has been designed to allow for adjustment of the gap for further optimization if necessary and/or desired (e.g., different powder materials, powder densities, blending patterns (e.g., swirling), blending times, other processing functions (e.g., drying, grinding, etc.) etc.); either shims/spacers or spring preload may be adjusted to change the gap. If necessary and/or desired, longer or different stiffness springs may also be substituted.

VRLM Suspension and Resonance

For this embodiment, the VRLM provides only attractive force and the return force is provided by a suspension of 8 coil springs arranged in 4 pairs. The spring rate of each is approximately 1000 lbf/in each, providing a net spring constant of approximately 8000 lbf/in. The moving mass (Mₘₒᵥₑ) of the empty chamber and motor armature (including coupling) is approximately 15 lb. Because the motor stator is held by a flexible suspension, its approximately 10 lb mass (Mₛₜₐₜₒᵣ) in also included in calculating the system equivalent mass and natural frequency:
M=Mₘₒᵥₑ*Mₛₜₐₜₒᵣ/(Mₘₒᵥₑ+Mₛₜₐₜₒᵣ); f=sqrt(k/M)/2*π˜115 Hz

Once fluidized, the observed powder often has little effect on the moving mass and the natural frequency seems quite insensitive to material loading (i.e., the fill height of the chamber and/or powder density). The powder material does seem to have an impact on the power dissipation in the system and the damping of the natural resonance. The normal operating (PWM) frequency is usually chosen slightly below the natural frequency (e.g., approximately 10-20 Hz below). PWM duty cycles of approximately 25% have a high percentage of energy in the fundamental frequency and, therefore, operating duty cycles of between approximately 15 to approximately 25% are common with high chamber fill (high power input). At approximately 100 Hz with approximately +/−100 mil displacement, the motor armature has a peak velocity of approximately 1.6 m/s and acceleration of approximately 1000 m/s² or 100 g.

General Acoustic Blending Observations

Empirically it has been found that effective powder bed fluidization and blending occurs over a range of frequencies, vessel-bed shapes, and amplitudes. At first order, frequency determines how close to the natural system frequency (resonance) the system operates. Operating near resonance acts as a displacement transformer or amplifier for a given electrical pulse width input. The same net effect can be obtained at a frequency further from resonance by increasing the amplitude. Additional studies can determine if one set of conditions is significantly more efficient in terms of blend uniformity per given amount of electrical power input. In general, it has been found that running at slightly lower frequency with an increase in amplitude is robust over a range of operating conditions. Similarly, both diaphragm and entire blender drive (EBD) seem to effectively produce the same powder bed fluidization, although there are some subtle differences in the secondary motions.

While effective fluidization and blending have been shown to occur over a wide range of chamber geometry and operating frequencies, these parameters do affect the detailed (e.g., secondary, tertiary, etc.) motions in the chamber. In addition to the basic fluidization and bubbling, other demonstrated powder motions include slower, larger scale convective motion and/or recirculation; smaller scale diffusion, turbulent mixing, cellular motion, and/or center “volcanoes”; swirling; and entrainment of powder in the air above the bed. Changes in the slower turning-rolling motion of the bed particularly are most noticeable at the chamber sides near the bed surface and near the outside of the piston/bottom. Contouring of the chamber bottom (and top) seems to have an effect on both guiding the motion of the particles near the wall and in preventing “dead zones” (i.e., regions of little or no blending) near the bottom outside diameter of the vessel. Therefore, chamber shape (e.g., conical bottom) seems to have a significant effect on the large scale blend uniformity (i.e., can eliminate dead zones).

The effect of chamber height has been observed experimentally by (1) removing the chamber cover and (2) inserting a variable height cover. Some effect was observed, particularly in the “air borne” powder above the fluidized bed and in the powder bed surface. Lowering the cover height increased the turbulence and entrainment of powder above the bed. The following sections discuss some of the potentially applicable basic acoustic principles which may help guide further experiments.

Lengthwise Chamber Acoustic Waves

Lengthwise acoustic waves, traveling and/or standing, are believed to be present in the blending chamber. Given the complex nature of the fluid-powder-vessel system, it is difficult to calculate how much of the acoustic power is reflected back into the chamber to form standing waves and how much will be transmitted out of the chamber. Reflection/transmission is believed to occur at both the fluidized bed surface where the acoustic properties change and at the chamber top. In addition, some acoustic energy can be absorbed within the bed.

The approximately 20 L clear cylinder chamber is approximately 16 inches tall and approximately 12 inches in diameter. Using the sound speed of ambient temperature air, the resonant or natural frequency (discounting the powder) (f) and resonant wavelength (λ) at a typical drive frequency of approximately 100 Hz are estimated:
c=350 m/s; f=c/2*1=350/(2*0.0254*16)=430 Hz
λ=c/f=69 in

Thus, the drive frequency below the acoustic resonant frequency and the resonant wavelength is longer than the vessel length, piston/chamber diameter, or powder depth. Thus, it is believed that standing waves will exist but are not expected to be highly resonant at the fundamental frequency.

Typical operating velocities can vary from approximately 1 m/s to approximately 100 m/s, such as 2 m/s, and typical operating Mach numbers can vary from approximately 0.00 to approximately 0.30, such as Ma˜0.01. Cross-sectional area variation along the lengthwise direction (e.g., cone or horn shapes) can be used to amplify the velocity and pressure at specific locations in order to enhance fluidization and/or mixing (e.g., increase velocity near the bottom).

It is believed that the losses introduced due to the particles in the gas acoustic field will increase effective damping of the acoustic field and facilitate the transfer of energy from the gas to the particles. In addition, it is believed that non-linear effects create a “DC” or hydrostatic pressure field that can help lift and fluidize. Non-linear acoustic radiation also creates a force on the interface between the gas and the particle bed that can result in an “acoustic fountain”.

Non-Lengthwise Acoustic Forces and Motion

The acoustic fluidized bed flow pattern exhibits considerable motion in addition to the basic fluidization motion. Much of it may be due to standard fluidized bed phenomena such as bubbling, gravity, and turbulence. In addition, acoustic fields may drive some of both high velocity/turbulence cellular sections (including the core) and the slower recirculating vortex pattern.

Non-Lengthwise Acoustic Wave Modes

In addition to pure lengthwise acoustic waves, non-normal waves may also be present in the chamber. Due to the cylindrical nature of the chamber, the resulting signal amplitude can be described by a Bessel function in the radial direction and a sinusoid in angular rotation:
Ψₙ(r,θ)Xₙ(x)˜Jₙ(n_{qm}*r/a)*sin(mθ)

For this model, waves with frequencies (k) above the cutoff frequency f_{c} will be propagating while those below will be evanescent:
f_{c}=1.84*c/2*π*a˜700 Hz

The Bessel function radial profile is consistent with the active “volcano” region often observed near the center of the blending chamber.

Piston Acoustic Radiation

The beam pattern is a function of the wave number-radius product (ka):
k=ω/c; ka=2*π*f*a/c˜0.3

As shown in FIG. 5-7 of Pierce's Acoustics, the radiation pattern will be fairly hemispherical for the fundamental frequency and lower harmonics.

Piston radiation patterns at higher frequencies may be important in some of the more complex motions and are probably more relevant with the earlier diaphragm-piston drive prototypes where the active piston was significantly smaller than the overall chamber.

Acoustic Streaming

Acoustic streaming is the steady (average) fluid motion induced by an oscillating (zero average) acoustic field. The effect has similarities to the “Reynolds stresses” of turbulent flows. Streaming occurs in both unbounded and bounded (boundary layer) flows such as the blending chamber. Acoustic streaming derives from higher order terms in the pressure-velocity fields and results in secondary recirculating flow patterns such as those observed in the chamber. Viscous drag from the streaming motion could impart motion to the particles.

Forces on Powder Particles

Three basic mechanisms could provide forces on the powder particles: (1) viscous drag from the air motion (both oscillating and steady streaming), (2) acoustic radiation pressure (levitation) and (3) steady non-linear acoustic “DC” or “hydrostatic” pressure gradients. In addition to these fluid forces on the particles, the non-linear properties associated with the contraction and expansion of the fluidized bed subjected to an oscillating gas flow could create a net fluidization effect.

Steady Fluidized Beds (Viscous Drag on Particles)

In a steady fluidized bed, the minimum fluidization velocity corresponds to the pressure drop (due to drag on the particles) just sufficient to support the weight of the particles of density p, in the bed of height h, with a void fraction of ε:
Δp=h*(l−ε)*ρ*g

Powder size ranges considerably. For estimating the particle Reynolds number, a typical size of approximately 5 mil and an air velocity of approximately 1 m/s is assumed, resulting a Reynolds number of approximately 10.

For Re<20, the following correlation applies for the minimum fluidization velocity:
U_{mf}=dₚ²*ρₚ*g*ε³*φ₂²/(150*μ*(l−ε))

The pressure and velocity for fluidization are both quite small and readily obtained by the transient (oscillating) motion and associated pressure. Steady acoustic streaming velocity may exceed the minimum fluidization velocity.

Radiation Pressure and Acoustic Levitation

In addition to the viscous drag on powder particles, acoustic radiation pressure will create a force upward. For a standing wave, Eqn (78) of Hamilton and Blackstock Chapter 6 can be used to estimate the levitating force (i.e., the force that exactly balances the force of gravity) on a particle:
F=(5*π/6)*A²kR³/ρc²*sin(2kz)

Using the above formula it is found that a modest pressure amplitude can create a levitating force.

Acoustically Generated Steady Pressure Gradient or Hydrostatic Pressure

Non-linear acoustic terms result in a steady second-order pressure gradient(s) which results in streaming flows if the gas is free to move. In the acoustically fluidized bed, this hydrostatic pressure could create “buoyancy” type forces if the particles are of different density than the surrounding gas.

### CONCLUSION

A particular embodiment of the basic acoustic (sonic) blender electrical-mechanical drive and operation has been at least partially characterized. Effective fluidization and blending has been achieved over a range of operating frequencies and chamber geometries.

Other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A machine, comprising:
a drive adapted to:
generate an acoustic standing wave in an impeller-less chamber, the acoustic standing wave having a velocity below approximately 0.3 Mach, the chamber containing particles, the chamber non-destructively detachable from the drive, a system comprising the drive, the chamber, and the particles defining a mechanical resonant frequency having a value either less than approximately 75 percent, or greater than approximately 125 percent, of an acoustic resonant frequency of the chamber; and
acoustically fluidize the particles contained in the chamber.

2. The machine of claim 1, further comprising a controller adapted to generate a drive signal.

3. The machine of claim 1, further comprising a controller adapted to provide a drive signal to said drive.

4. The machine of claim 1, further comprising a controller adapted to provide a pulse width modulated drive signal to said drive.

5. The machine of claim 1, further comprising a controller adapted to control said drive based on a plurality of predetermined drive parameters.

6. The machine of claim 1, further comprising a controller adapted to control said drive based on a plurality of user-provided drive parameters.

7. The machine of claim 1, further comprising:
a controller adapted to provide a drive signal to said drive; and
a menu-driven user interface for said controller.

8. The machine of claim 1, further comprising the impeller-less chamber.

9. The machine of claim 1, further comprising the impeller-less chamber, the impeller-less chamber defining a longitudinal axis, a length oriented substantially parallel to said longitudinal axis, and an opposing pair of ends, the chamber adapted to receive particles.

10. The machine of claim 1, further comprising the impeller-less chamber, which is substantially transparent.

11. The machine of claim 1, further comprising the impeller-less chamber, which is devoid of moving mechanical parts.

12. The machine of claim 1, further comprising the impeller-less chamber, which is adapted to receive particles having an average maximum dimension between approximately 1 micrometer and approximately 1000 micrometers.

13. The machine of claim 1, further comprising the impeller-less chamber, which is adapted to receive particles to a fill level of between approximately 3 percent and approximately 90 percent of an internal volume of said impeller-less chamber.

14. The machine of claim 1, further comprising the impeller-less chamber, at least one end of an opposing pair of ends of said chamber shaped to enhance circulation of particles contained in said chamber.

15. The machine of claim 1, wherein said drive is adapted to substantially thoroughly mix particles contained in the chamber.

16. The machine of claim 1, wherein said drive is adapted to levitate particles contained in the chamber.

17. The machine of claim 1, wherein said drive is adapted to circulate particles contained in the chamber.

18. The machine of claim 1, wherein said drive is adapted to substantially thoroughly mix particles contained in the chamber within approximately 2 minutes.

19. The machine of claim 1, wherein said drive is adapted to process particles contained in the chamber to less than approximately 2 percent relative standard deviation of a mixedness parameter.

20. The machine of claim 1, wherein said drive comprises a motor.

21. The machine of claim 1, wherein said drive comprises a linear motor.

22. The machine of claim 1, wherein said drive comprises a non-contact linear motor.

23. The machine of claim 1, wherein said drive is bearing-free.

24. A method comprising a plurality of activities, comprising:
via a drive:
generating an acoustic standing wave in an impeller-less chamber, the acoustic standing wave having a velocity below approximately 0.3 Mach, the chamber containing particles, the chamber non-destructively detachable from the drive, a system comprising the drive, the chamber, and the particles defining a mechanical resonant frequency having a value either less than approximately 75 percent, or greater than approximately 125 percent, of an acoustic resonant frequency of the chamber; and
acoustically fluidizing particles contained in the chamber.

25. The method of claim 24, further comprising, via the drive, substantially thoroughly mixing particles contained in the chamber.

26. The method of claim 24, further comprising, via the drive, levitating particles contained in the chamber.

27. The method of claim 24, further comprising, via the drive, circulating particles contained in the chamber.

28. The method of claim 24, further comprising, via the drive, substantially thoroughly mixing particles contained in the chamber within approximately 2 minutes.

29. A machine-readable medium containing instructions for activities comprising:
receiving a plurality of predetermined drive parameters;
based on a plurality of predetermined parameters, generating a pulse width modulated drive signal from a controller to a drive, the signal adapted to cause the drive to:
generate an acoustic standing wave in an impeller-less chamber, the acoustic standing wave having a velocity below approximately 0.3 Mach, the chamber containing particles, the chamber non-destructively detachable from the drive, a system comprising the drive, the chamber, and the particles defining a mechanical resonant frequency having a value either less than approximately 75 percent, or greater than approximately 125 percent, of an acoustic resonant frequency of the chamber; and
acoustically fluidize particles contained in the chamber.

30. The machine-readable medium of claim 29, further comprising, based on a plurality of predetermined parameters, determining properties of the drive signal.

31. The machine-readable medium of claim 29, further comprising rendering properties of the drive signal.

32. The machine-readable medium of claim 29, wherein at least a subset of the predetermined drive parameters are user-provided.

33. The machine-readable medium of claim 29, wherein at least a subset of the predetermined drive parameters are user-provided via a menu-based user interface.

34. The machine-readable medium of claim 29, wherein at least a subset of the predetermined drive parameters are user-provided via a graphical user interface.
